(19) United States
(12) Patent Application Publication
(10) Pub. No.: US 2020/0039198 A1
(43) Pub. Date: Feb. 6, 2020

(54) THERMALLY EXPANDABLE SHEET AND METHOD OF PRODUCING THREE-DIMENSIONAL OBJECT

(71) Applicant: CASIO COMPUTER CO., LTD., Tokyo (JP)

(72) Inventors: Kenji IWAMOTO, Tokyo (JP); Yuji HORIUCHI, Tokyo (JP); Yoshimune MOTOYANAGI, Tokyo (JP); Satoshi MITSUI, Tokyo (JP); Hiroshi MOROKUMA, Tokyo (JP)

(73) Assignee: CASIO COMPUTER CO., LTD., Tokyo (JP)

(21) Appl. No.: 16/525,394

(22) Filed: Jul. 29, 2019

(30) Foreign Application Priority Data
Aug. 3, 2018 (JP) 2018-147207

(51) Int. Cl. B32B 27/20; B32B 27/08; B32B 27/10; B32B 3/26; B29C 61/04

(52) U.S. Cl. CPC B32B 27/20; B32B 27/08; B32B 27/10; B29K 2105/165; B29C 61/04; B32B 2307/734; B32B 3/263

(57) ABSTRACT

A thermally expandable sheet including two or more thermally expandable layers that are laminated, the thermally expandable layers each expanding upon being heated to or above a predetermined expansion start temperature, wherein
the thermally expandable layers include two adjacent layers different from each other in the expansion start temperature.

### FIELD

The present invention relates to a thermally expandable sheet and a method of producing a three-dimensional object.

### BACKGROUND

Thermoplastic resin materials (oligomer or the like) in which foaming microcapsules, which expand upon being heated, are dispersed serve as a raw material for a porous foam member and are used for fillers, heat insulators, buffer materials, cushioning materials, and the like. Such a material can be expanded to protrude so that a front surface can have unevenness. Thus, the material is coated on a base material and then is expanded, to be usable for decorative items such as a wall paper (for example, JP 3954157 B2). Furthermore, unevenness can be formed by locally heating the material coated over the entire surface. Specifically, a relief-shaped three-dimensional object having a predetermined uneven shape formed on the front surface can be easily manufactured through printing a thermally expandable sheet including films of the above described resin material containing microcapsules laminated on a base material having a film shape, and irradiating the sheet with near infrared rays (for example, JP H1-28660 A).

This will be described with reference to a cross-sectional view in the upper part of FIG. 11. A thermally expandable sheet 110 is formed in the following manner Specifically, a resin material, in which microcapsules are dispersed, is coated on a base material 2 with low stretchability made of thick paper so that a thermally expandable layer 101 is formed. Then, a front surface of the thermally expandable layer 101 is covered with an ink receiving layer 3 so that the sheet can be used in an ink jet printer. Then, black ink 4 is printed on a pattern of an area to be a protruded on the front surface (on the ink receiving layer 3) on the side of the thermally expandable layer 101 of the thermally expandable sheet 110. When a print surface is irradiated with near infrared rays, the black ink 4 with high light absorbency emits heat, and as illustrated in the lower part of FIG. 11, a portion of the thermally expandable layer 101 in an area immediately below the black ink 4 and an area around such area gradually expands to protrude and bulge towards the front surface not fixed on the base material 2. Furthermore, the degree of expansion of the microcapsules varies depending on the heating temperature. Thus, an uneven shape with different expansion heights can be formed with the temperature of the heat emitted by the black ink 4 adjusted based on a gray scale of the black ink 4. Specifically, a temperature range in which the microcapsules expand varies depending on the type of volatile solvent to be contained in the microcapsule and the like. The temperature range is defined by an expansion start temperature T_{Es} serving as the lower limit and a maximum expansion temperature T_{Emax} at which an expansion coefficient becomes the largest. At a high temperature exceeding the maximum expansion temperature T_{Emax}, contraction occurs, and thus the expansion coefficient decreases. In FIG. 11, the thermally expandable layer 101 is represented by a dot pattern indicating microcapsules, with the degree of expansion (expansion coefficient) represented by the sizes (diameters) of the dots (circles).

The microcapsule-containing resin material expands to have the volume increased by 1000% from that before the expansion, depending on the composition of the microcapsule and the like. Therefore, for example, a three-dimensional object with a larger level difference on the front surface may be manufactured using a thermally expandable sheet with a thermally expandable layer formed to be thick. In the thermally expandable layer 101 of the thermally expandable sheet 110, a surface layer near the black ink 4, serving as the heat source first expands (the left side in the lower part in FIG. 11), and then heat propagates in the depth direction (thickness direction) so that a deep part (lower layer) expands (the right side in the lower part in FIG. 11). FIG. 12 illustrates how the temperature of the black ink 4 as well as the temperatures of the surface layer and the deep part of the thermally expandable layer 101 transition in the thermally expandable sheet 110.

In response to the start of irradiation of the near infrared rays, the black ink (4) emits heat to have the temperature rising to reach heating temperature (maximum temperature) defined in accordance with its density. Here, the heating temperature is set to the maximum expansion temperature T_{Emax} of the thermally expandable layer 101. The black ink will be naturally cooled once the irradiation of the near infrared rays is terminated after a predetermined time has elapsed. Temperature rise of a surface layer (101s) of the thermally expandable layer 101 is slightly delayed from that of the black ink 4. The surface layer (101s) starts to expand when the temperature reaches the expansion start temperature T_{Es}. As a result of the expansion, the distance from the black ink 4 increases, and the heat conductivity is reduced due to the inclusion of the bubbles, resulting in slower heat propagation. Thus, the temperature rise speed becomes slower than that of the black ink 4. However, due to a small distance before the expansion, these factors have limited impact, and thus the temperature rise would not be excessively slower. Then, when the temperature reaches the maximum expansion temperature T_{Emax}, after the black ink 4 has reached the temperature, the expansion progresses at the highest speed, and then stops when the temperature drops to or below the expansion start temperature T_{Es} as a result of stopping the irradiation of the near infrared rays. The expansion may also stop even when the temperature is within the expansion temperature range, once the microcapsules are expanded to the maximum level (saturation).

The temperature rise of the deep part (101d) of the thermally expandable layer 101 starts even later than the surface layer. Furthermore, when a part of the thermally expandable layer 101, that is, the surface layer starts to expand, the distance from the deep part (101d) to the black ink 4 increases, resulting a deceleration of the temperature rise speed. Thus, it takes time for the deep part (101d) to reach the expansion start temperature T_{Es}. Furthermore, the temperature rise speed of the deep part (101d) gradually further decreases after the deep part (101d) reaches the expansion start temperature T_{Es} due to the expansion of the thermally expandable layer 101 (101s and 101d). Such factor further causes the deep part (101d) to reach the maximum expansion temperature T_{Emax} much later than the surface layer. In view of this, in order to expand the thermally expandable layer 101 to have a sufficient thickness as a whole, the black ink 4 needs to be continuously heated even after the expansion of the surface layer is saturated. This results in low productivity and low energy efficiency in near infrared ray irradiation. Such a disadvantageous effect becomes more serious as the thickness of the thermally expandable layer 101 increases.

Furthermore, in the thermally expandable sheet 110, the heat from the black ink 4 not only propagates in the thickness direction but also propagates in an in-plane direction. Thus, the thermally expandable layer 101 expands also on the outside of the area immediately below the black ink 4. This means that a longer heating time for increasing the expansion height (thickness) leads to a protruding area expanding more beyond the pattern of the black ink 4, resulting in unevenness of the surface being smooth. Thus, the uneven shape is difficult to control.

An object of the present invention is to provide a thermally expandable sheet in which a thermally expandable layer is largely expanded efficiently and an uneven shape on a front surface can be easily controlled.

### SUMMARY

A thermally expandable sheet including two or more thermally expandable layers that are laminated, the thermally expandable layers each expanding upon being heated to or above a predetermined expansion start temperature, wherein

the thermally expandable layers include two adjacent layers different from each other in the expansion start temperature.

A thermally expandable sheet including three layers of thermally expandable layers that are laminated on one-side surface of a base material, wherein

an expansion start temperature of a first thermally expandable layer that is a middle layer of the three thermally expandable layers is higher than the expansion start temperature of a second thermally expandable layer that is provided as an upper layer of the first thermally expandable layer, and

an expansion start temperature of a third thermally expandable layer provided as a lower layer of the first thermally expandable layer is higher than the expansion start temperature of the first thermally expandable layer.

A thermally expandable sheet including four layers of the thermally expandable layers laminated on one-side surface of a base material, wherein

a second one of the thermally expandable layers from the one-side surface of the base material starts to expand at an expansion start temperature that is higher than expansion start temperatures of other ones of the thermally expandable layers.

### BRIEF DESCRIPTION OF DRAWINGS

FIG. 1 is a cross-sectional view schematically illustrating the configuration of a thermally expandable sheet according to a first embodiment of the present invention;

FIG. 2A is a schematic cross-sectional view for explaining a method of producing a three-dimensional object using the thermally expandable sheet according to the first embodiment of the present invention, illustrating a printing step;

FIG. 2B is a schematic cross-sectional view for explaining the method of producing a three-dimensional object using the thermally expandable sheet according to the first embodiment of the present invention, illustrating a light irradiation step;

FIG. 3 illustrates a model for explaining how the temperature and expansion height transition as a result of heating the thermally expandable sheet according to the present invention;

FIG. 4 is a cross-sectional view of a three-dimensional object using the thermally expandable sheet according to the first embodiment of the present invention;

FIG. 5 is a cross-sectional view schematically illustrating the configuration of a thermally expandable sheet according to a modification of the first embodiment of the present invention;

FIG. 6 is a cross-sectional view schematically illustrating the configuration of a thermally expandable sheet according to a second embodiment of the present invention;

FIG. 7A is a schematic cross-sectional view for explaining a method of producing a three-dimensional object using the thermally expandable sheet according to the second embodiment of the present invention, illustrating a printing step;

FIG. 7B is a schematic cross-sectional view for explaining the method of producing a three-dimensional object using the thermally expandable sheet according to the second embodiment of the present invention, illustrating a light irradiation step;

FIG. 8 is a cross-sectional view schematically illustrating the configuration of the thermally expandable sheet according to a third embodiment of the present invention;

FIG. 9A is a schematic cross-sectional view for explaining a method of producing a three-dimensional object using the thermally expandable sheet according to the third embodiment of the present invention, illustrating a printing step;

FIG. 9B is a schematic cross-sectional view for explaining the method of producing a three-dimensional object using the thermally expandable sheet according to the third embodiment of the present invention, illustrating a front surface light irradiation step;

FIG. 9C is a schematic cross-sectional view for explaining the method of producing a three-dimensional object using the thermally expandable sheet according to the third embodiment of the present invention, illustrating a back surface light irradiation step;

FIG. 10 is a cross-sectional view schematically illustrating the configuration of a thermally expandable sheet according to a modification of the third embodiment of the present invention;

FIG. 11 is a cross-sectional view for schematically explaining steps in a method of producing a three-dimensional object using a conventional thermally expandable sheet; and

FIG. 12 illustrates a model for explaining how the temperature transitions as a result of heating the conventional thermally expandable sheet.

### DETAILED DESCRIPTION

Hereinafter, modes for carrying out the present invention will be described in detail with reference to the drawings. However, the modes illustrated below illustrate thermally expandable sheets for embodying the technical thought of embodiments, and not limiting. The members illustrated in the drawings may have an exaggerated size, positional relationship, or the like, for the sake of clarity, and may have a simplified shape. Further, in the following description, the same or similar members and steps are denoted by the same reference numerals, and the description will be omitted as appropriate.

### First Embodiment

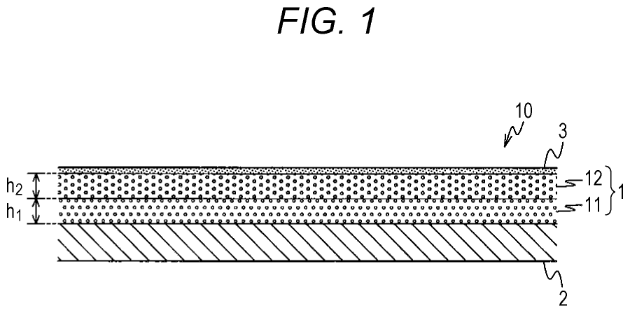

A configuration of a thermally expandable sheet according to a first embodiment of the present invention will be described with reference to FIG. 1. FIG. 1 is a cross-sectional view schematically illustrating the configuration of the thermally expandable sheet according to the first embodiment of the present invention. In the present specification, the thermally expandable sheet is a material mainly used for a three-dimensional object, and the three-dimensional object is a sheet-like printed object that is partially thick to have unevenness on one-side surface.

As illustrated in FIG. 1, a thermally expandable sheet 10 according to the first embodiment of the present invention is a sheet-like flexible member having a uniform thickness, and is formed by laminating a base material 2, a thermally expandable laminated film 1, and an ink receiving layer 3 in this order. The thermally expandable laminated film 1 is a two-layer film formed by laminating a first thermally expandable layer 11 and a second thermally expandable layer 12 in this order from the side of the base material 2. The thermally expandable sheet 10 is a printing target object having a front side surface, that is, the ink receiving layer 3 to be printed with black ink. Thus, the thermally expandable sheet 10 is designed to have a size (a standard size) usable in a printer for producing a three-dimensional object, and may have any size (an A4 sheet size for example) equal to or larger than that of the three-dimensional object.

(Base Material)

The base material 2 supports the soft thermally expandable laminated film 1 on its surface, and has a strength (rigidity) sufficient for the thermally expandable sheet 10 to serve as a printing target object, and for preventing the thermally expandable sheet 10 from having wrinkles or largely corrugating even when the thermally expandable laminated film 1 is partially expanded. The base material 2 also has sufficient flexibility to be usable in a conveyance mechanism in a coating device and a printer in a process of forming the thermally expandable laminated film 1 (the first thermally expandable layer 11 and the second thermally expandable layer 12). Preferably, the base material 2 further has heat resistance, as well as low thermal conductivity. In the present specification, the heat resistance refers to the heat resistance against the temperature during production of the three-dimensional object, and particularly to the heating temperature for expanding the thermally expandable layers 11 and 12. Specifically, the base material 2 includes thick paper, a heat-resistant resin film having low stretchability, or the like.

(First Thermally Expandable Layer and Second Thermally Expandable Layer)

The thermally expandable laminated film 1 is a main element of the thermally expandable sheet 10, and partially expands to protrude on the side of the front surface not fixed to the base material 2, so that the unevenness is produced on the front surface. The first thermally expandable layer 11 and the second thermally expandable layer 12 (collectively referred to as the thermally expandable layers 11 and 12 as appropriate) that are components of the thermally expandable laminated film 1 are each a member that expands upon being heated to be in a predetermined temperature range (expansion temperature range), are coated films formed to have uniform thicknesses h₁ and h₂, and have a configuration that is similar to that in known thermally expandable sheets. Specifically, the thermally expandable layers 11 and 12 contain thermally expandable microcapsules and thermoplastic resin serving as a binder, and may further contain a white pigment such as titanium oxide and a pigment other than black (not containing carbon black) to be colored in a desired color. The microcapsule has a diameter of several to several tens of μm, has a shell formed of thermoplastic resin, contains a volatile solvent, and expands, upon being heated to be in an expansion temperature range, to a size corresponding to the heated temperature and a heated time period. Thus, when the thermally expandable layers 11 and 12 are heated to reach the lower limit (expansion start temperature) of the expansion temperature range, the thermally expandable layers 11 and 12 start to expand and expand more as the temperature increases. Then, upon exceeding the temperature at which the microcapsules reaches the maximum expansion coefficient (maximum expansion temperature), the microcapsules shrink and the expansion coefficient decreases. As the volatile solvent, hydrocarbon such as butane (C4H₁₀) is used, for example, and the expansion temperature range is determined depending on the boiling point. Thus, the expansion temperature range of the microcapsules varies depending on what is contained in the capsule, and the expansion start temperature can be appropriately designed from a low temperature of about 70° to a high temperature close to 300° C.

In the present invention, the first thermally expandable layer 11 and the second thermally expandable layer 12 are different from each other in the expansion start temperature. An expansion start temperature T_{E2s} of the second thermally expandable layer 12 on the front surface side is higher than an expansion start temperature T_{E1s} of the first thermally expandable layer 11 on the side of the base material 2 (T_{E1s}<T_{E2s}). A larger thickness h₂ of the second thermally expandable layer 12 results in a larger difference (T_{E2s}−T_{E1s}) between the temperatures. A maximum expansion temperature T_{E2max} of the second thermally expandable layer 12 is preferably higher than a maximum expansion temperature T_{E1max} of the first thermally expandable layer 11 (T_{E1max}<T_{E2max}). The relationship between the maximum expansion temperature T_{E1max} of the first thermally expandable layer 11 and the expansion start temperature T_{E2s} of the second thermally expandable layer 12 is not particularly defined, but in order to form a three-dimensional object with a stepwise expansion height, the expansion start temperature T_{E2s} of the second thermally expandable layer 12 is preferably higher (T_{E1max}<T_{E2s}). The thermal properties of the thermally expandable layers 11 and 12 will be described in detail in a description on a method of producing a three-dimensional object to be given later.

A larger sum of the thicknesses of the thermally expandable layers 11 and 12 (h₁+h₂), that is, a larger thickness of the thermally expandable laminated film 1 can provide a three-dimensional object having a larger expansion height. On the other hand, a smaller thickness h₂ of the second thermally expandable layer 12 enables a protruding area of the front surface to be easily controlled to have a desired shape, so that a three-dimensional object having surface unevenness with a larger level difference can be obtained. Furthermore, the thickness (depth) of the first thermally expandable layer 11 from the front surface can be increased only by a limited amount based on the expansion temperature range (T_{E1s}, T_{E1max}) and the maximum expansion temperature T_{E2max} and thickness h₂ of the second thermally expandable layer 12 is limited. Thus, the thickness h₁ is preferably designed based on these aspects.

A local expansion of the thermally expandable laminated film 1 is attributable to local heating of the thermally expandable laminated film 1, which is caused by a photothermal conversion member 4 emitting heat as a result of converting light emitted thereon. This photothermal conversion member 4 is black ink provided on the front surface of the thermally expandable sheet 10 in a method of producing a three-dimensional object as described later.

(Ink Receiving Layer)

The thermally expandable layers 11 and 12 are generally hydrophobic layers onto which ink is difficult to attach before expansion. Thus, the ink receiving layer 3 is provided to be the front most surface of the thermally expandable sheet 10 so that the black ink (photothermal conversion member 4) and/or color ink can be attached in the method of producing the three-dimensional object. The ink receiving layer 3 is one used for a general ink jet printer printing paper and is formed to have a thickness of about 10 to several tens of μm depending on a material and the like. The material includes a microporous type material (such as porous silica and alumina) that allows the ink to be absorbed in micro pores and a swelling type material (such as highly absorbent polymer) that absorbs the ink and swells. In the present invention, the ink receiving layer 3 is preferably a microporous type featuring excellent heat resistance.

(Method of Producing Thermally Expandable Sheet)

The thermally expandable sheet 10 according to the first embodiment can be manufactured by a method that is the same as that for producing a known thermally expandable sheet. The thermally expandable laminated film 1 is formed as follows. First of all, thermally expandable microcapsules as components of the first thermally expandable layer 11 and a thermoplastic resin solution, as well as a white pigment if necessary are mixed to prepare a slurry. The slurry is coated on the base material 2 by a coating device, dried, and, if necessary, overcoated, whereby the first thermally expandable layer 11 having a uniform thickness h₁ is formed. Similarly, a slurry, which is a raw material of the second thermally expandable layer 12, is coated on the first thermally expandable layer 11 to form a second thermally expandable layer 12 having a uniform thickness h₂. The coating device may be a known apparatus using a bar coater, a roller, a spray, or the like. In particular, the device is preferably of the bar coater type which is advantageous in terms of uniform thick coating. Thereafter, a slurry that is a raw material of the ink receiving layer 3 is coated on the second thermally expandable layer 12 to form the ink receiving layer 3. The resultant object is cut to have an A4 paper size or the like, using a cutting machine. Thus, the thermally expandable sheet 10 is obtained.

(Method of Producing Three-Dimensional Object)

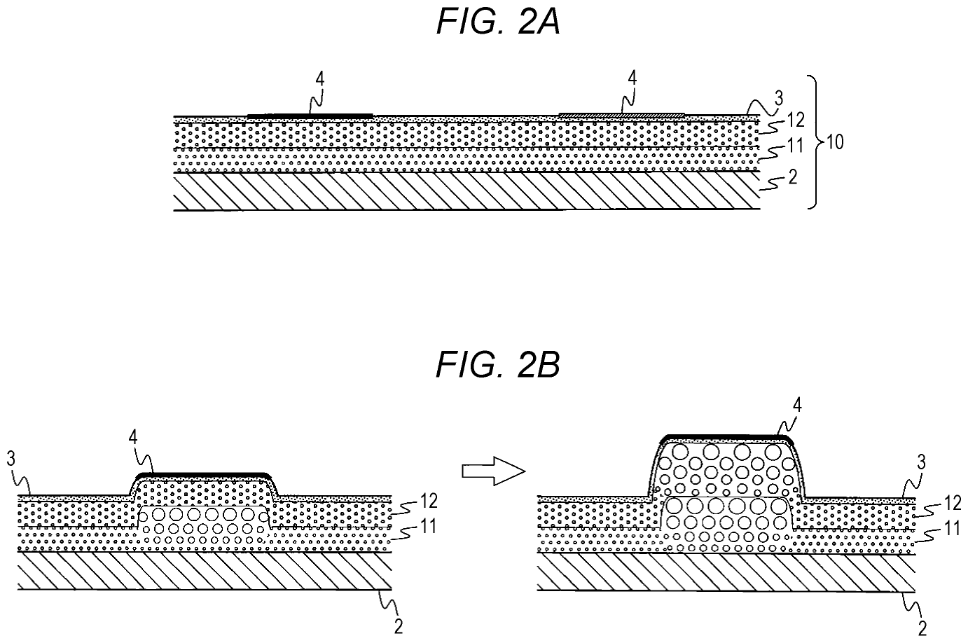

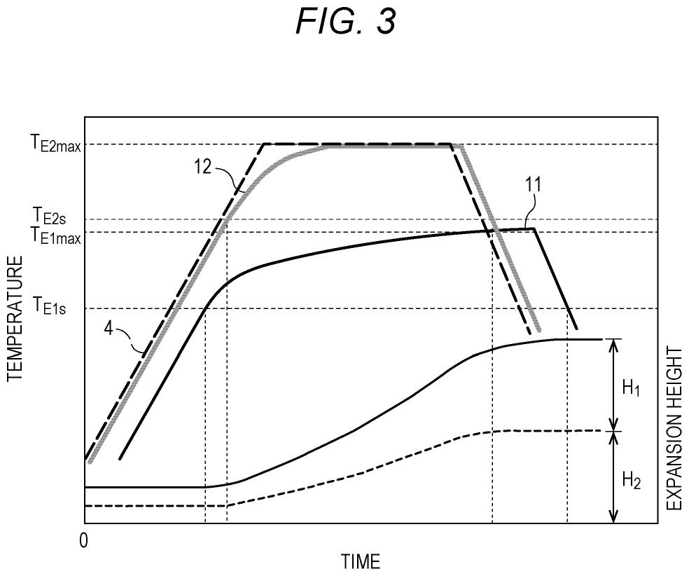

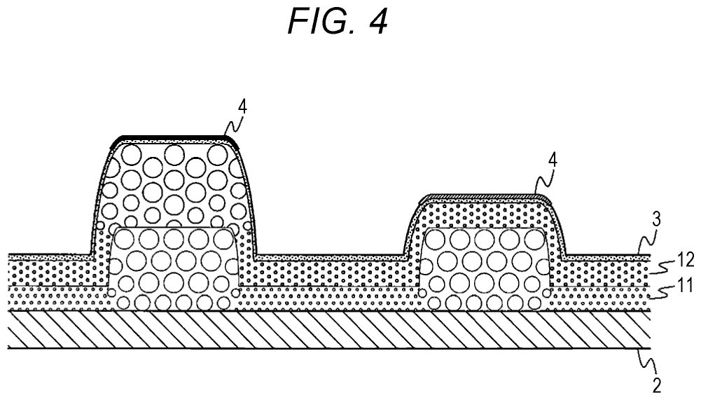

A method for expanding the thermally expandable sheet according to the first embodiment will be described together with the description on the method of producing a three-dimensional object using the thermally expandable sheet, with reference to FIGS. 2A, 2B, 3, and 4. FIGS. 2A and 2B are schematic cross-sectional views for explaining the method of producing a three-dimensional object using the thermally expandable sheet according to the first embodiment of the present invention. FIG. 2A illustrates a printing step, and FIG. 2B illustrates a light irradiation step. FIG. 3 illustrates a model for explaining how the temperature and expansion height transition as a result of heating the thermally expandable sheet according to the present invention. FIG. 4 is a cross-sectional view of a three-dimensional object using the thermally expandable sheet according to the first embodiment of the present invention. In the method of producing a three-dimensional object using the thermally expandable sheet according to the present embodiment, the printing step and the light irradiation step are sequentially performed as in a case where a known thermally expandable sheet is used.

In the printing step, as illustrated in FIG. 2A, the black ink to serve as the photothermal conversion member 4 is printed, on the ink receiving layer 3 on the front surface of the thermally expandable sheet 10, in a pattern corresponding to the shape of the area to be protruded in the three-dimensional object. The printer may be selected from known devices such as an offset printer and an inkjet printer depending on print quality and the like, under a condition that the printing target object would not be heated to or higher than the expansion start temperature T_{E1s} of the first thermally expandable layer 11. Furthermore, if necessary, a desired image pattern may be printed on the front surface of the thermally expandable sheet 10 by full color printing or the like, at or after the timing when the photothermal conversion member 4 is printed. The image pattern is made by using ink of color cyan (C), magenta (M), and/or yellow (Y), without using the black ink containing carbon black. Now, a description will be given on the photothermal conversion member.

The photothermal conversion member 4 is a monochrome or gray scale pattern formed on the front surface of the thermally expandable sheet 10, as illustrated in FIG. 2A. The photothermal conversion member 4 is a member that absorbs light in a specific wavelength range (for example, near infrared rays with a wavelength of 780 nm to 2.5 μm), converts the absorbed light into heat, and emits the heat. Specifically, the photothermal conversion member 4 is made of ink of black color (K) including carbon black that is widely used for printing. The temperature of the heat emitted by the photothermal conversion member 4 irradiated with light varies in accordance with tint, that is, the gray scale (black density) of the carbon black per area. The thermally expandable laminated film 1 of the thermally expandable sheet 10 expands based on this temperature, so that the surface becomes uneven. FIG. 2A illustrates a single color pattern of high density (black) on the left side and a single color of a medium density (gray) on the right side. In the present specification, “light” is near infrared rays (near infrared light) converted into heat by carbon black of the photothermal conversion member 4 unless otherwise stated. In addition, what is converted into heat is not limited to light, and electromagnetic waves including radio waves can be employed if they can be converted in to heat.

In the light irradiation step, the printed surface for the photothermal conversion member 4, that is, the front surface of the thermally expandable sheet 10 is irradiated with light including near infrared rays. The light irradiation device which irradiates the thermally expandable sheet 10 with near infrared rays can be a well-known apparatus for forming a three-dimensional object using a thermally expandable sheet. Specifically, the light irradiation device mainly includes a conveyance mechanism that conveys a sheet-like irradiation target object in one direction as in a printer, a light source that emits light, including near infrared rays, to be converted into heat by the photothermal conversion member 4, a reflector plate, and a cooler for cooling the light irradiation device. The light source is, for example, a halogen lamp, and is provided over the entire width of the irradiation target object. The reflector plate is formed as a substantially semi-cylindrical pillar having a curved surface on a surface of the pillar and a mirror surface on the inner side, and covers the side of the light source opposite to the side facing the irradiation target object, so that the irradiation target object can be efficiently irradiated with light from the light source. The cooler is of an air-cooling type (fan), a liquid-cooling type (radiator), or the like, and is provided in the vicinity of the reflector plate.

Light emitted onto the thermally expandable sheet 10 is incident on and absorbed by the photothermal conversion member 4, to be converted into heat. Then, the photothermal conversion member 4 is heated to a temperature corresponding to its black density. This heat propagates in the thickness direction from the front surface to the second thermally expandable layer 12. As a result, the first thermally expandable layer 11 is heated. Then, as illustrated on the left side of FIG. 2B, in an area immediately below the photothermal conversion member 4, the first thermally expandable layer 11 starts to expand upon reaching a temperature at or higher than the expansion start temperature T_{E1s}. In this process, the first thermally expandable layer 11 has the lower side fixed to the base material 2, and thus expands toward the front surface while causing the soft second thermally expandable layer 12 on the upper side thereof to extend. Note that the photothermal conversion member 4 in FIG. 2B is one with the black pattern on the left side in FIG. 2A. In the cross-sectional views for explaining the method of producing a three-dimensional object in FIG. 2B and in a second embodiment and after, the thermally expandable layers 11 and 12 are represented by a dot pattern representing a microcapsule, with the size (diameter) of a dot (circle) representing the degree of expansion (expansion coefficient).

Then, upon reaching a temperature at or higher than the expansion start temperature T_{E2s}, the second thermally expandable layer 12 start to expand following the expansion of the first thermally expandable layer 11 as illustrated on the right side of FIG. 2B. When a predetermined period of time (short period of time) elapses after the thermally expandable sheet 10 has ceased to be irradiated with light, the second thermally expandable layer 12 and the first thermally expandable layer 11 are respectively cooled down to temperatures lower than the expansion start temperatures T_{E2s} and T_{E1s}, respectively. Thus, the expansion ends.

How the temperature of each of the photothermal conversion member 4 and the thermally expandable layers 11 and 12 transitions and how the expansion height of the thermally expandable laminated film 1 transitions in the light irradiation step will be described in detail. As illustrated in FIG. 3, when the light irradiation starts, the photothermal conversion member (4) generates heat to have temperature rising to reach a heating temperature (maximum temperature) corresponding to its density. Here, the heating temperature is set to the maximum expansion temperature T_{E2max} of the second thermally expandable layer 12. The second thermally expandable layer (12) has a temperature rise, slightly delayed from that of the photothermal conversion member 4, and starts to expand when the temperature reaches the expansion start temperature T_{E2s}. Specifically, the second thermally expandable layer 12 has the thickness (h₂) gradually increasing so that a distance from the photothermal conversion member 4 increases in the lower layer, and inclusion of bubbles leads to a low thermal conductivity leading to a slow thermal propagation. These factors result in the slower temperature rise than the photothermal conversion member 4. However, due to a small distance (equal to or smaller than h₂) before the expansion, these factors have limited impact, and thus the temperature rise would not be excessively slower. Then, when the second thermally expandable layer 12 reaches a temperature (maximum expansion temperature T_{E2max}) equivalent to that of the photothermal conversion member 4, the speed of expansion reaches the maximum speed. Then, when the temperature drops after the light irradiation is stopped, the speed of expansion decreases. The expansion stops when the temperature drops to or below the expansion start temperature T_{E2s}.

The temperature rise of the first thermally expandable layer 11 is even more delayed, that is, occurs after the temperature rise of the second thermally expandable layer 12. Still, the expansion start temperature T_{E1s} is low, and thus the first thermally expandable layer 11 starts expanding with its temperature reaching the expansion start temperature T_{E1s} and the thickness (H₁) gradually increases before the second thermally expandable layer 12 starts expanding. As in the case of the second thermally expandable layer 12, the temperature rise speed of the first thermally expandable layer 11 decreases as a result of the expansion, and then further decreases when the second thermally expandable layer 12 starts to expand. As in the case of the second thermally expandable layer 12, the first thermally expandable layer 11 is heated to have the temperature increasing toward the maximum expansion temperature T_{E2max} (the heating temperature), and thus the expanding speed gently increases at a lower speed than the second thermally expandable layer 12. Then, the first thermally expandable layer 11 reaches a temperature close to its maximum expansion temperature T_{E1max}, but before the temperature further rises, the temperatures of the photothermal conversion member 4 and the second thermally expandable layer 12 sequentially drop as a result of stopping the light irradiation. Thus, the temperature does not rise any further. Instead, temperature drop starts after the temperature drop f the second thermally expandable layer 12. The expansion stops when the temperature drops to or below the expansion start temperature T_{E1s} In this manner, the first thermally expandable layer 11 continues to expand even after the second thermally expandable layer 12 stops expanding. Thus, as finally illustrated on the left side of FIG. 4, the first thermally expandable layer 11 expands to the same extent as the second thermally expandable layer 12, hereby a three-dimensional object can be obtained with the thermally expandable layers 11 and 12 largely expanded. Furthermore, the time period required for completing the expansion of the first thermally expandable layer 11 is shortened. As a result, the thermally expandable layers 11 and 12 (the second thermally expandable layer 12 in particular) are within the expansion temperature range for a shorter period of time. This results in a smaller amount of heat propagating in an in-plane direction. Thus, the expansion of the layers can be limited within an area not largely spreading from the area immediately below the photothermal conversion member 4.

As described above, since the first thermally expandable layer 11 reaches the expansion start temperature T_{E1s} before the second thermally expandable layer 12 reaches the expansion start temperature T_{E2s}, the first thermally expandable layer 11, far from the photothermal conversion member 4 serving as a heat source, can expand to the same extent as the second thermally expandable layer 12, without being heated over a long time. The second thermally expandable layer 12 may reach the expansion start temperature T_{E2s} first. In such a case, the first thermally expandable layer 11 preferably reaches the expansion start temperature T_{E1s} within a shorter period of time thereafter. Furthermore, the black density of the photothermal conversion member 4, as well as the light intensity, time, and the like of the light irradiation are set so as to prevent the temperatures of the first thermally expandable layer 11 and the second thermally expandable layer 12 from exceeding temperatures around their maximum expansion temperatures T_{E1max} and T_{E2max}. Specifically, the temperatures of the first thermally expandable layer 11 and the second thermally expandable layer 12 are preferably not higher than T_{E1max}+5° C. and T_{E2max}+5° C., and are more preferably not higher than T_{E1max} and T_{E2max}.

Furthermore, the black density of the photothermal conversion member 4 may be adjusted to set the heating temperature to be not lower than the expansion start temperature T_{E1s} or more of the first thermally expandable layer 11 and lower than the expansion start temperature T_{E2s} of the second thermally expandable layer 12, so that only the first thermally expandable layer 11 can be expanded as illustrated on the right side in FIG. 4. In particular, when T_{E1max}<T_{E2s} holds true, the expanded layer(s) may be selected from two options: the first thermally expandable layer 11 alone or both of the first thermally expandable layer 11 and the second thermally expandable layer 12, so that stepwise expansion height can be easily obtained.

(Modification)

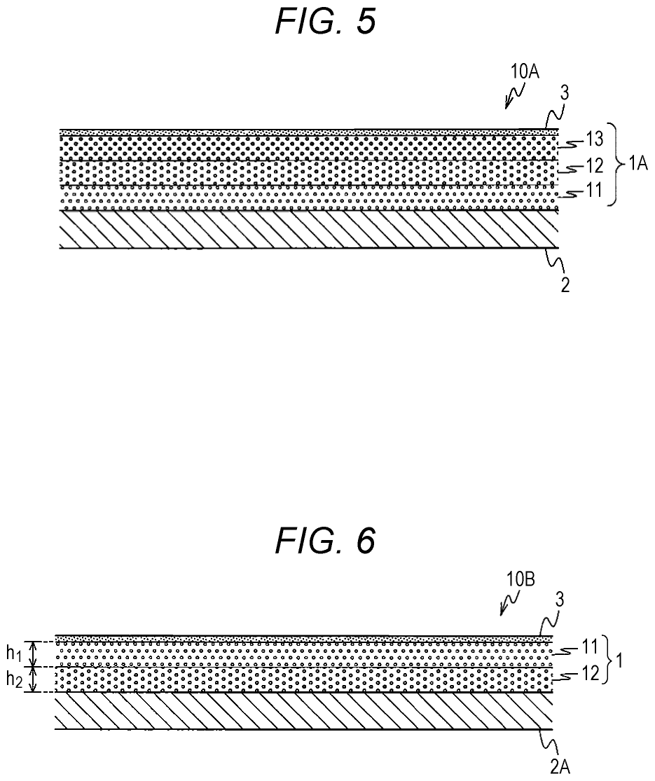

The thermally expandable sheet according to the present embodiment may have three or more thermally expandable layers, having different expansion start temperatures, laminated. Hereinafter, a thermally expandable sheet according to a modification of the first embodiment of the present invention will be described with reference to FIG. 5. FIG. 5 is a cross-sectional view schematically illustrating the configuration of the thermally expandable sheet according to the modification of the first embodiment of the present invention. Elements that are the same as those in the above-described embodiment (see FIG. 1) are denoted by the same reference numerals, and the description thereof will be omitted.

As illustrated in FIG. 5, a thermally expandable sheet 10A according to the modification of the first embodiment is formed by laminating the base material 2, a thermally expandable laminated film 1A, and the ink receiving layer 3 in this order. The thermally expandable laminated film 1A is a three-layer film formed by laminating the first thermally expandable layer 11, the second thermally expandable layer 12, and a third thermally expandable layer 13 in this order from the side of the base material 2. The third thermally expandable layer 13 has a higher expansion start temperature than the second thermally expandable layer 12. Thus, the relationship between the second thermally expandable layer 12 and the third thermally expandable layer 13 is similar to the relationship between the first thermally expandable layer 11 and the second thermally expandable layer 12.

With the thermally expandable sheet 10A according to the present modification, the thermally expandable laminated film 1A can be provided to be thick, so that a three-dimensional object with a larger expansion height can be obtained. Alternatively, the thicknesses of each of the thermally expandable layers 11, 12, 13 can be made small, so that the uneven shape on the front surface can be easily controlled. In addition, layers to be expanded are selected from the three options: the first thermally expandable layer 11 alone, two layers of the thermally expandable layers 11 and 12, or all three layers of the thermally expandable layers 11, 12, and 13, which makes it easy to provide stepwise expansion heights.

### Second Embodiment

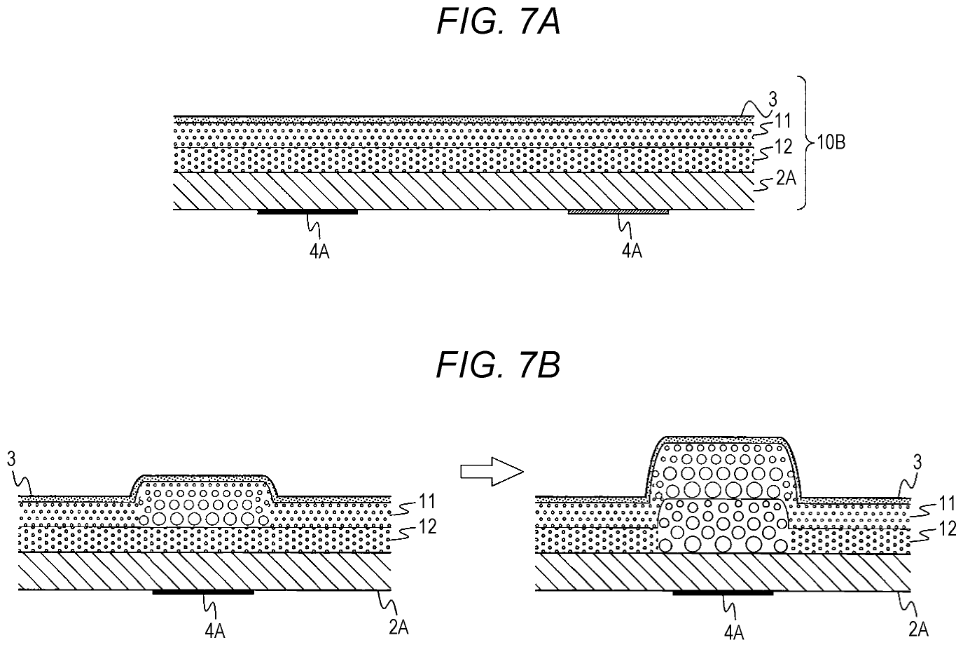

The thermally expandable sheet according to the first embodiment is used for obtaining a three-dimensional object with a pattern of the black ink printed on the front side surface on which the thermally expandable layer (thermally expandable laminated film) is provided. Furthermore, a three-dimensional object can be obtained with the printing performed on the back side surface, that is, on the base material. Hereinafter, a thermally expandable sheet according to a second embodiment of the present invention will be described with reference to FIG. 6. FIG. 6 is a cross-sectional view schematically illustrating the configuration of the thermally expandable sheet according to the second embodiment of the present invention. The same elements as those of the first embodiment (see FIGS. 1 to 5) are denoted by the same reference numerals, and the description thereof will be omitted.

As illustrated in FIG. 6, a thermally expandable sheet 10B according to the second embodiment of the present invention is similar to the thermally expandable sheet 10 according to the first embodiment (see FIG. 1), and formed is by laminating a base material 2A, the thermally expandable laminated film 1, and the ink receiving layer 3 in this order. The thermally expandable laminated film 1 is formed by laminating the second thermally expandable layer 12 and the first thermally expandable layer 11 from the side of the base material 2A. Thus, the thermally expandable sheet 10B is obtained by swapping the laminated orders of the first thermally expandable layer 11 and the second thermally expandable layer 12 from those in the thermally expandable sheet 10 according to the first embodiment. The thermally expandable sheet 10B is a printing target object to have the black ink printed at least on the back side surface. The configurations of the thermally expandable layers 11 and 12 and the ink receiving layer 3 are similar to those in the first embodiment. The base material 2A has a configuration similar to that of the base material 2 of the first embodiment, but preferably has a small thickness as long as necessary strength can be obtained so that heat can easily propagate in the thickness direction. Furthermore, the base material 2A includes the ink receiving layer 3 if necessary for printing the black ink on the back surface (not illustrated).

(Method of Producing Three-Dimensional Object)

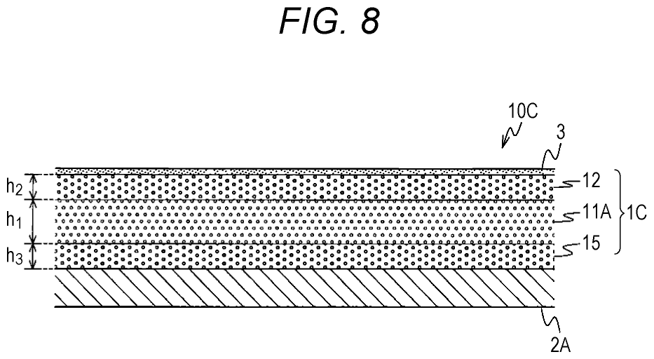

A method for expanding the thermally expandable sheet according to the second embodiment will be described together with a method of producing a three-dimensional object using the thermally expandable sheet, with reference to FIGS. 7A and 7B. FIGS. 7A and 7B are schematic cross-sectional views for explaining the method of producing a three-dimensional object using the thermally expandable sheet according to the second embodiment of the present invention. FIG. 7A illustrates a printing step, and FIG. 7B illustrates a light irradiation step. In the method of producing a three-dimensional object using the thermally expandable sheet according to the present embodiment, the printing step and the light irradiation step are performed in order as in the second embodiment.

In the printing step, as illustrated in FIG. 7A, black ink serving as a photothermal conversion member 4A is printed on the surface (back surface) of the thermally expandable sheet 10B on the side of the base material 2A. The photothermal conversion member 4A is formed as a mirror image of the pattern of the shape of the area to be protruded in the three-dimensional object. Furthermore, since the heat emitted from the photothermal conversion member 4A is transmitted to the thermally expandable laminated film 1 via the base material 2A, the thermally expandable laminated film 1 tends to expand in an outwardly extended region from the area immediately above the photothermal conversion member 4A. Thus, the photothermal conversion member 4A is formed in a smaller pattern than the protruding area compared to that in the first embodiment. Other than that, the photothermal conversion member 4A has the same configuration as the photothermal conversion member 4 of the first embodiment. Further, subsequent to or before the printing of the photothermal conversion member 4A, a desired image pattern may be printed on the ink receiving layer 3 on the front surface of the thermally expandable sheet 10B with color ink including black ink.

In the light irradiation step, the printed surface for the photothermal conversion member 4A, that is, the back surface of the thermally expandable sheet 10B is irradiated with light including near infrared rays. The photothermal conversion member 4A is heated to a temperature corresponding to its black density, and the heat propagates in the thickness direction from the back surface through the base material 2A and the second thermally expandable layer 12, so that the first thermally expandable layer 11 is heated. Then, as illustrated on the left side of FIG. 7B, in the area immediately above the photothermal conversion member 4A, the first thermally expandable layer 11 reaches a temperature at or higher than the expansion start temperature T_{E1s} or more and starts expanding. Thereafter, as illustrated on the right side of FIG. 7B, the second thermally expandable layer 12 reaches a temperature at or higher than the expansion start temperature T_{E2s} and starts expanding.

As described above, similarly to the thermally expandable sheet 10 according to the first embodiment, since the first thermally expandable layer 11 reaches the expansion start temperature T_{E1s} before the second thermally expandable layer 12 reaches the expansion start temperature T_{E2s}, the first thermally expandable layer 11 and the second thermally expandable layer 12 can be largely expanded by a similar amount. Furthermore, since the black pattern is printed on the back surface of the thermally expandable sheet 10B, the image pattern on the front surface of the three-dimensional object becomes clear. In the present embodiment, since the first thermally expandable layer 11 is provided to the front surface only with the ink receiving layer 3 with a small thickness provided in between, a temperature drop of the first thermally expandable layer 11 follows a temperature drop of the second thermally expandable layer 12 almost without delay, after the light irradiation is stopped. Therefore, since the first thermally expandable layer 11 stops expanding in a shorter period of time after the light irradiation has been stopped as compared with the first embodiment, Thus, the light irradiation time and the like are set based on such a condition.

(Modification)

The thermally expandable sheet according to the present embodiment does not necessarily include the ink receiving layer 3 on the thermally expandable laminated film 1 if no image pattern is printed on the surface. Furthermore, the thermally expandable sheet according to the present embodiment may be provided with three or more layers of thermally expandable layers having different expansion start temperatures, as in the modification of the first embodiment (see FIG. 5). That is, the thermally expandable laminated film 1A formed by laminating the third thermally expandable layer 13, the second thermally expandable layer 12, and the first thermally expandable layer 11 from the side of the base material 2A can be provided.

### Third Embodiment

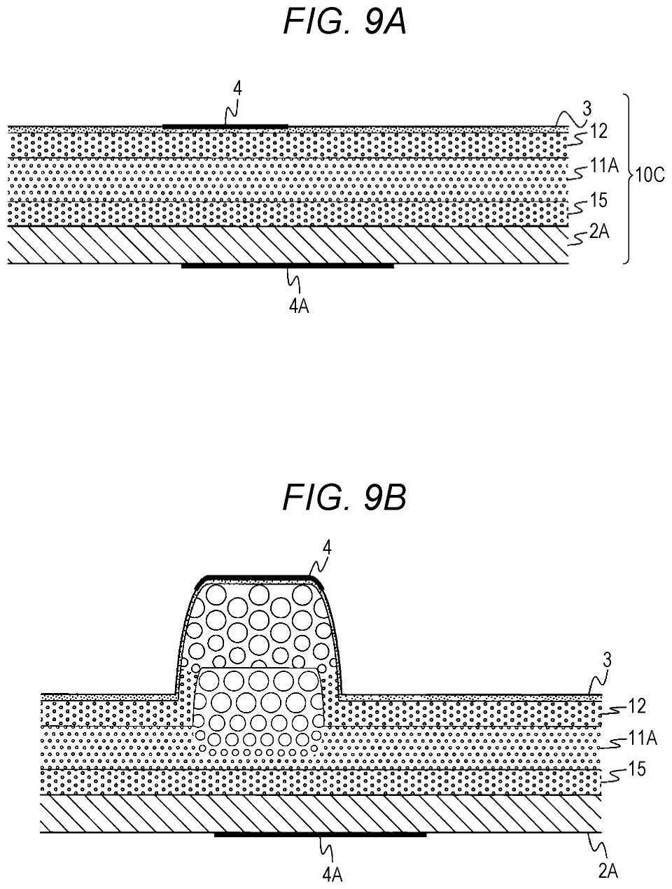

The thermally expandable sheet according to the present invention can also be irradiated with light from both sides to obtain a three-dimensional object with an even large amount of expansion. Hereinafter, a thermally expandable sheet according to a third embodiment of the present invention will be described with reference to FIG. 8. FIG. 8 is a cross-sectional view schematically illustrating the configuration of the thermally expandable sheet according to the third embodiment of the present invention. The same elements as those of the first and second embodiments (see FIGS. 1 to 7) are denoted by the same reference numerals, and the description thereof will be omitted.

As illustrated in FIG. 8, a thermally expandable sheet 10C according to a third embodiment of the present invention is formed by laminating the base material 2A, a thermally expandable laminated film 1C, and the ink receiving layer 3 in this order. The thermally expandable laminated film 1C is a three-layer film formed by laminating a third thermally expandable layer 15, a first thermally expandable layer 11A, and the second thermally expandable layer 12 in this order from the side of the base material 2A. The thermally expandable sheet 10C is a printing target object to have the black ink printed on both side surfaces. The configuration of the base material 2A is the same as that in the second embodiment. The configuration of the ink receiving layer 3 is the same as that in the first embodiment.

The configurations of the first thermally expandable layer 11A and the second thermally expandable layer 12 are the same as those of the first thermally expandable layer 11 and the second thermally expandable layer 12 in the first embodiment, and the relationship between the expansion start temperatures T_{E1s} and T_{E2s} are also the same (T_{E1s}<T_{E2s}). However, since the first thermally expandable layer 11A has an upper layer and a lower layer that are separately expanded as described later in a description on a method of producing a three-dimensional object given below, the first thermally expandable layer 11A can be designed to have a thickness h₁ suitable for this structure. The third thermally expandable layer 15 is similar to the second thermally expandable layer 12 in its relationship with the first thermally expandable layer 11A. Specifically, its expansion start temperature T_{E3s} is higher than the expansion start temperature T_{E1s} of the first thermally expandable layer 11A (T_{E1s}<T_{E3s}). The relationship between the second thermally expandable layer 12 and the third thermally expandable layer 15 is not particularly defined, and their thermal properties such as the expansion start temperatures T_{E2s} and T_{E3s} and thicknesses h₂ and h₃ may be the same or different.

(Method of Producing Three-Dimensional Object)

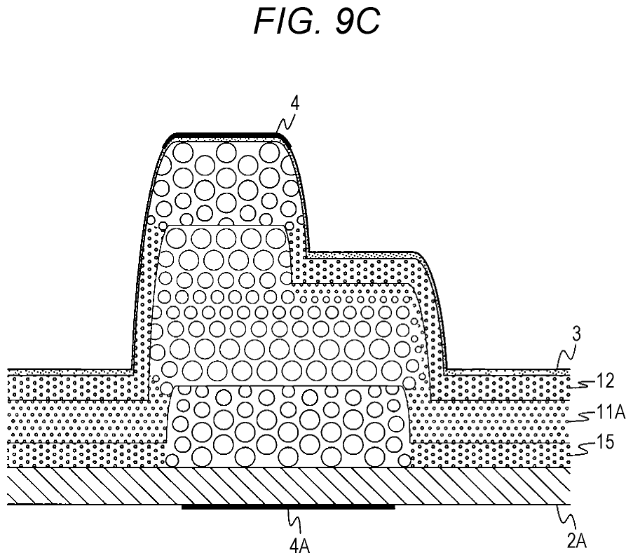

A method for expanding the thermally expandable sheet according to the third embodiment will be described together with a method of producing a three-dimensional object using the thermally expandable sheet, with reference to FIGS. 9A, 9B, and 9C. FIGS. 9A, 9B, and 9C are schematic cross-sectional views for explaining the method of producing a three-dimensional object using the thermally expandable sheet according to the third embodiment of the present invention. FIG. 9A illustrates a printing step, FIG. 9B illustrates a front surface light irradiation step, and FIG. 9C illustrates a back surface light irradiation step. In the method of producing a three-dimensional object using the thermally expandable sheet according to the present embodiment, the printing step, the front surface light irradiation step, and the back surface light irradiation step are sequentially performed as in a case where a known thermally expandable sheet is used and light irradiation is performed on both surfaces.

In the printing step, as illustrated in FIG. 9A, the black ink serving as the photothermal conversion member 4 is printed on the ink receiving layer 3 on the front surface of the thermally expandable sheet 10C, and black ink serving as the photothermal conversion member 4A is printed on the base material 2A on the back surface of the thermally expandable sheet 10C. The configurations of the photothermal conversion members 4 and 4A are the same as those in the first and second embodiments, respectively. Furthermore, if necessary, a desired image pattern may be printed on the front surface of the thermally expandable sheet 10C by using color ink other than the black ink, at or after the timing when the photothermal conversion member 4 is printed.

In the front surface light irradiation step, the front surface of the thermally expandable sheet 10C is irradiated with light including near infrared rays. As in the light irradiation step (see FIG. 2B) in the first embodiment, the photothermal conversion member 4 is heated to a temperature corresponding to its black density, and the first thermally expandable layer 11A and the second thermally expandable layer 12 sequentially start to expand in the area immediately below the photothermal conversion member 4. Here, the heating temperature is set to the maximum expansion temperature T_{E2max} of the second thermally expandable layer 12. As illustrated in FIG. 9B, in the front surface light irradiation step, the second thermally expandable layer 12 expands to an expansion height corresponding to the maximum expansion temperature T_{E2max}. On the other hand, in the first thermally expandable layer 11A, the upper layer expands to the same extent as the second thermally expandable layer 12. However, heat does not propagate to the lower layer largely separated from the photothermal conversion member 4, and thus, the lower layer expands in a small amount or does not expand at all.

In the back surface light irradiation step, the back surface of the thermally expandable sheet 10C is irradiated with light including near infrared rays. As in the light irradiation step (see FIG. 7B) in the second embodiment, the photothermal conversion member 4A is heated to a temperature corresponding to its black density, and the first thermally expandable layer 11A and the third thermally expandable layer 15 sequentially start to expand in the area immediately above the photothermal conversion member 4A. Here, the heating temperature is set to a maximum expansion temperature T_{E3max} of the third thermally expandable layer 15. As illustrated in FIG. 9C, in the back surface light irradiation step, the third thermally expandable layer 15 expands to an expansion height corresponding to the maximum expansion temperature T_{E3max}. On the other hand, the lower layer of the first thermally expandable layer 11A, that is, the portion that does not greatly expand in the front surface light irradiation step, expands to the same extent as the third thermally expandable layer 15.

In this manner, both surfaces are irradiated with light to divide the first thermally expandable layer 11A, far from the light irradiation surface, into the upper layer and the lower layer and expand them separately. In this process, since the first thermally expandable layer 11A starts expanding before the second thermally expandable layer 12 or the third thermally expandable layer 15, both of which are near the irradiation surface, the thermally expandable layer 11A can expand to the same extent as the thermally expandable layers 12 and 15.

(Modification)

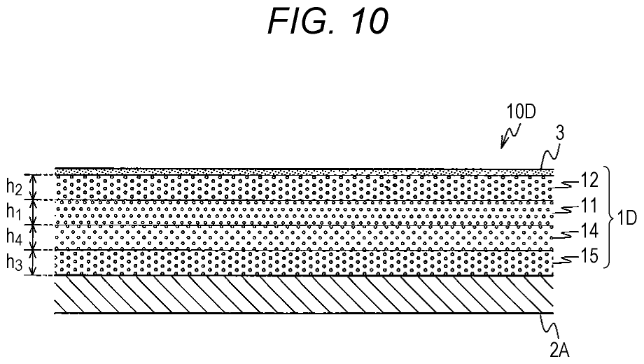

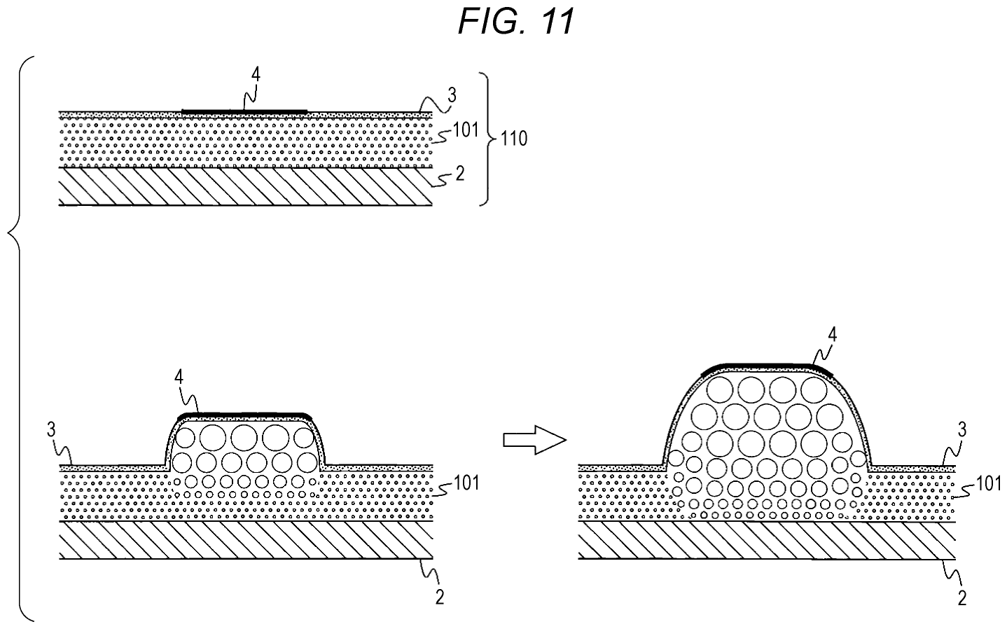

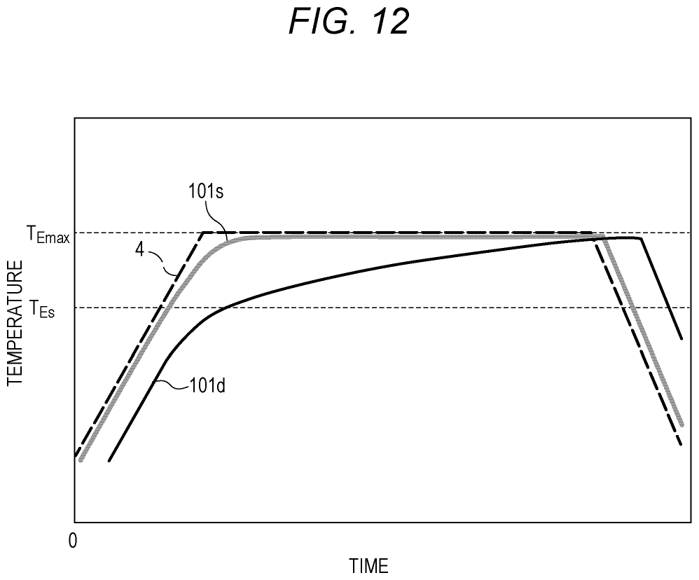

In the thermally expandable sheet according to the present embodiment, the first thermally expandable layer may be divided into two layers (upper and lower layers) having different expansion start temperatures. Hereinafter, a thermally expandable sheet according to a modification of the third embodiment of the present invention will be described with reference to FIG. 10. FIG. 10 is a cross-sectional view schematically illustrating the configuration of the thermally expandable sheet according to the modification of the third embodiment of the present invention. The same elements as those in the first, second, and third embodiments (see FIGS. 1 to 9) are denoted by the same reference numerals, and the descriptions thereof will be omitted.

As illustrated in FIG. 10, a thermally expandable sheet 10D according to the modification of the third embodiment is formed by laminating the base material 2A, a thermally expandable laminated film 1D, and the ink receiving layer 3 in this order. The thermally expandable laminated film 1D is a four-layer film formed by laminating the third thermally expandable layer 15, a fourth thermally expandable layer 14, the first thermally expandable layer 11, and the second thermally expandable layer 12 in this order from the side of the base material 2A. In the present modification, the first thermally expandable layer 11A of the thermally expandable sheet 10C (see FIG. 8) according to the third embodiment is configured to be divided into two layers (the first thermally expandable layer 11 and the fourth thermally expandable layer 14) having different expansion start temperatures.

The fourth thermally expandable layer 14 has a lower expansion start temperature than the third thermally expandable layer 15 (T_{E4s}<T_{E3s}), and has a thickness h₄ that is designed in the same manner as the thickness h₁ of the first thermally expandable layer 11 in the first embodiment. That is, the relationship between the fourth thermally expandable layer 14 and the third thermally expandable layer 15 is the same as the relationship between the first thermally expandable layer 11 and the second thermally expandable layer 12. The first thermally expandable layer 11 and the fourth thermally expandable layer 14 have different expansion start temperatures. Here, the expansion start temperature T_{E4s} of the fourth thermally expandable layer 14 is lower than the expansion start temperature T_{E1s} of the first thermally expandable layer 11 (T_{E4s}<T_{E1s}). That is, in the thermally expandable sheet 10D, the thermally expandable layers 11, 12, 14, 15 are designed such that T_{E4s}<T_{E1s}<T_{E2s} and T_{E4s}<T_{E3s} are satisfied.

Similar to the thermally expandable sheet 10C according to the third embodiment, the thermally expandable sheet 10D according to the present modification sequentially undergoes a printing step of printing the photothermal conversion members 4 and 4A on both surfaces, a front surface light irradiation step, and a back surface light irradiation step to have the thermally expandable laminated film 1D expanded. In the present modification, the second thermally expandable layer 12 and the first thermally expandable layer 11 are expanded in the front surface light irradiation step. In this step, a portion (upper layer) of the fourth thermally expandable layer 14, having the lower expansion start temperature T_{E4s}, near the first thermally expandable layer 11 also expands. On the other hand, in the back surface light irradiation step, the third thermally expandable layer 15 and the fourth thermally expandable layer 14 are expanded, but the black density and the like of the photothermal conversion member 4A are designed such that the first thermally expandable layer 11 does not expand as much as possible. Therefore, it is easier to control the expansion height and the uneven shape of the surface.

As another modification of the third embodiment, as in the thermally expandable sheet 10A (see FIG. 5) according to the modification of the first embodiment, the thermally expandable layer 13 having an expansion start temperature higher than that of the second thermally expandable layer 12 may be laminated on the second thermally expandable layer 12. In such a thermally expandable sheet, the thermally expandable layers 13 and 12 and the upper layer of the first thermally expandable layer 11A are expanded in the front surface light irradiation step.

Furthermore, for example, in the thermally expandable sheet 10 (see FIG. 1) according to the first embodiment, the photothermal conversion members 4 and 4A may be printed on both surfaces and both surfaces may be irradiated with light. That is, the second thermally expandable layer 12 and the upper layer of the first thermally expandable layer 11 are expanded in the front surface light irradiation step, and only the first thermally expandable layer 11 is expanded in the back surface light irradiation step.

The thermally expandable sheets according to the present invention can also be expanded by heating by a method other than pattern formation with black ink and light irradiation. For example, a heated metal mold or the like may be brought into contact or hot air may be blown.

The use of the thermally expandable sheets according to the present invention is not limited to three-dimensional objects. For example, the sheets may be formed of a thermally expandable laminated film without a base material, and may be attached to an object with an adhesive or the like or provided directly with a coating film, and then the sheet may be heated from the surface for expansion. Furthermore, the use is not limited to decorative members. The sheets can be used by being attached to building materials in walls, windows, and the like, to serve as a sheet-like cushioning material, such as a foam sheet or an air cushion, or as a heat insulating material.

The present invention is not limited to the above embodiments, and modifications can be made without departing from the spirit of the present invention.

1. A thermally expandable sheet comprising two or more thermally expandable layers that are laminated, the thermally expandable layers each expanding upon being heated to or above a predetermined expansion start temperature, wherein
the thermally expandable layers include two adjacent layers different from each other in the expansion start temperature.

2. The thermally expandable sheet according to claim 1, wherein
the thermally expandable layers are provided on one-side surface of a base material, and
one of the thermally expandable layers closer to the base material than another one of the thermally expandable layers has the expansion start temperature lower than the expansion start temperature of another one of the thermally expandable layers.

3. The thermally expandable sheet according to claim 2 further comprising an ink receiving layer provided on one of the thermally expandable layers, wherein
a photothermal conversion material that causes the thermally expandable layers to expand is formed on one surface of the ink receiving layer.

4. The thermally expandable sheet according to claim 1, wherein
the thermally expandable layers are provided on one-side surface of a base material, and
one of the thermally expandable layers closer to the base material than another one of the thermally expandable layers has the expansion start temperature higher than the expansion start temperature of another one of the thermally expandable layers.

5. The thermally expandable sheet according to claim 4, wherein a photothermal conversion material that causes the thermally expandable layers to expand is formed on another-side surface of the base material.

6. A thermally expandable sheet comprising three layers of thermally expandable layers that are laminated on one-side surface of a base material, wherein
an expansion start temperature of a first thermally expandable layer that is a middle layer of the three thermally expandable layers is higher than the expansion start temperature of a second thermally expandable layer that is provided as an upper layer of the first thermally expandable layer, and
an expansion start temperature of a third thermally expandable layer provided as a lower layer of the first thermally expandable layer is higher than the expansion start temperature of the first thermally expandable layer.

7. The thermally expandable sheet according to claim 6 further comprising an ink receiving layer provided on the second thermally expandable layer, wherein
photothermal conversion materials that cause the thermally expandable layers to expand are formed on one-side surface of the ink receiving layer and on another-side surface of the base material.

8. The thermally expandable sheet according to claim 7, wherein the photothermal conversion material formed on the one-side surface of the ink receiving layer and the photothermal conversion material formed on the other-side surface of the base material are formed to at least partially overlap, with the thermally expandable layers provided in between.

9. A thermally expandable sheet comprising four layers of the thermally expandable layers laminated on one-side surface of a base material, wherein
a second one of the thermally expandable layers from the one-side surface of the base material starts to expand at an expansion start temperature that is higher than expansion start temperatures of other ones of the thermally expandable layers.

10. The thermally expandable sheet according to claim 9, wherein
the four thermally expandable layers laminated include a first thermally expandable layer, a second thermally expandable layer, a third thermally expandable layer, and a fourth thermally expandable layer laminated in this order with the first thermally expandable layer being adjacent to the base material, and
the second thermally expandable layer has an expansion start temperature that is lower than an expansion start temperature of each of the first thermally expandable layer and the third thermally expandable layer.

11. The thermally expandable sheet according to claim 10, wherein the third thermally expandable layer has the expansion start temperature that is lower than an expansion start temperature of the fourth thermally expandable layer.

12. The thermally expandable sheet according to claim 10 further comprising an ink receiving layer provided on the fourth thermally expandable layer, wherein
a photothermal conversion material that causes the thermally expandable layers to expand is formed on one-side surface of the ink receiving layer and on another-side surface of the base material.

13. The thermally expandable sheet according to claim 1, wherein
the thermally expandable layers each contains microcapsules dispersed, the microcapsules each including hydrocarbon, and
the ones of the thermally expandable layers different from each other in the expansion start temperature are different from each other in a boiling point of the hydrocarbon in the microcapsules.

14. A method of producing a three-dimensional object, the method comprising:
printing a photothermal conversion material on the thermally expandable layers of the thermally expandable sheet according to claim 2, the photothermal conversion material causing the thermally expandable layers to expand; and
irradiating the photothermal conversion material with light to cause the photothermal conversion material to convert the light into heat that causes the thermally expandable layers to expand.

15. A method of producing a three-dimensional object, the method comprising:
printing a photothermal conversion material on another-side surface of the base material of the thermally expandable sheet according to claim 4, the photothermal conversion material causing the thermally expandable layers to expand; and
irradiating the photothermal conversion material with light to cause the photothermal conversion material to convert the light into heat that causes the thermally expandable layers to expand.

16. A method of producing a three-dimensional object, the method comprising:
printing photothermal conversion materials on the thermally expandable layers and on another-side surface of the base material of the thermally expandable sheet according to claim 6, the photothermal conversion material causing the thermally expandable layers to expand; and
irradiating the photothermal conversion material with light to cause the photothermal conversion material to convert the light into heat that causes the thermally expandable layers to expand.

17. A method of producing a three-dimensional object, the method comprising:
printing photothermal conversion materials on the thermally expandable layers and on another-side surface of the base material of the thermally expandable sheet according to claim 9, the photothermal conversion material causing the thermally expandable layers to expand; and
irradiating the photothermal conversion material with light to cause the photothermal conversion material to convert the light into heat that causes the thermally expandable layers to expand.
